(19) United States
(12) Patent Application Publication
(10) Pub. No.: US 2009/0180025 A1
(43) Pub. Date: Jul. 16, 2009

(54) METHOD AND APPARATUS FOR OVERLAYING GRAPHICS ON VIDEO

(75) Inventor: Thomas Patrick Dawson, Escondido, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/400,943

(22) Filed: Mar. 10, 2009

Related U.S. Application Data
(63) Continuation-in-part of application No. 10/156,907, filed on May 28, 2002, now Pat. No. 7,530,084.

(51) Int. Cl. H04N 9/74; H04N 5/66

(52) U.S. Cl. 348/578; 348/739; 348/E09.055; 348/E05.133

(57) ABSTRACT

Information received on a side channel from a TV content source is placed in a graphics plane of a TV and overlaid onto a video plane of the TV, which contains content from a main channel. The graphics plane content in each side channel may be keyed to content ratings setting so that the TV selects the side channel appropriate for a user-input rating setting of the TV and overlays the content of the side channel onto the video plane, to thereby conform the composite image that is displayed on the TV to the viewer-input ratings setting.

This is a continuation in part of allowed co-pending U.S. patent application Ser. No. 10/156,907, filed May 28, 2002, from which priority is claimed.

### I. FIELD OF THE INVENTION

The present invention relates to completing parts of a video plane by overlaying graphic content from the graphics plane onto the video plane.

### II. BACKGROUND OF THE INVENTION

Concealing part of video is routinely performed today for a variety of reasons. For example, if a particular part of a video is deemed not suitable for viewing by the public in general, then that part of the video not suitable for viewing is concealed by a blurring operation of the part of the video deemed not suitable. When the video is then viewed, the blurred part of the video would conceal the not suitable material but would still allow the rest of the video content to be viewed.

Sometimes an entire video channel is concealed from viewing by a scrambling operation. This may be done when a monthly access fee is needed to be paid so as to view a subscription channel. If the fee is not paid, then the video is concealed from viewing by scrambling the video channel to render the video un-viewable.

In both of the above examples, the concealing operation is performed by embedding the blurred part of the image of the video into the video signal or by performing a scrambling operation on the channel delivering the video. This concealing operation is performed on the video signal itself prior to being received by the displaying device. There is no method at present to reconstruct the original image at the receiving device.

Other kinds of operations which embed images onto the video include adding out-takes and behind the scenes footage. Again, these kind of additions are added to the video signal prior to it's being received by a receiving device for display. There is no method at present to allow the user to choose whether they wish to enable or disable viewing of this additional material.

### SUMMARY OF THE INVENTION

An apparatus includes a TV display, a processor associated with the TV, and a tangible computer-readable storage medium accessible to the processor and bearing instructions to cause the processor to execute logic. The logic includes receiving a main content video stream from a content source. A video plane is established based on the main content video stream. The logic also includes receiving plural graphics content streams. Each graphic content stream is associated with a respective content. rating. A rating setting that is input by a user of the TV display is accessed and based on the rating setting, a first one of the graphics content streams is selected. A graphics plane is established using the first graphics content stream and then overlaid onto the video plane.

In some embodiments the graphics content stream in the graphics plane covers at least one predetermined region of the video plane. The predetermined region is not the entire video plane. The predetermined region of the video plane may be devoid of content, or the predetermined may contain content that is screened from view by the graphics content stream in the graphics plane.

In example implementations the plural graphics content streams are received from the content source. In specific implementations the plural graphics content streams are received from the content source on side channels associated with a main channel on which the main content video stream is received. Or, the plural graphics content streams can be received from the content source on the main channel itself.

In another embodiment, an apparatus includes a TV display, a processor associated with the TV, and a tangible computer-readable storage medium accessible to the processor and bearing instructions to cause the processor to execute logic. The logic includes receiving a main content video stream from a content source. A video plane is established based on the main content video stream. The logic also includes receiving one or more graphics content streams and establishing a graphics plane using the graphics content stream. The graphics plane is overlaid onto the video plane such that the graphics content stream in the graphics plane covers at least one predetermined region of the video plane. The predetermined region of the video plane includes a placard indicating that “full” content can be obtained for remuneration, and upon verification of a remuneration signal from the processor, a signal is received by the processor to use the graphics content stream.

In another embodiment, an apparatus includes a TV display, a processor associated with the TV, and a tangible computer-readable storage medium accessible to the processor and bearing instructions to cause the processor to execute logic. The logic includes receiving a main content video stream from a content source, with a video plane being established based on the main content video stream. The main content video stream is a full video stream, and the logic executed by the processor includes automatically placing at least one placard in a graphics plane and overlaying the graphics plane on the video plane to block at least one predetermined location of the video plane. The logic removes the placard from view upon receipt of an authorization signal.

In another embodiment, an apparatus includes a TV display, a processor associated with the TV, and a tangible computer-readable storage medium accessible to the processor and bearing instructions to cause the processor to execute logic. The logic includes receiving a main content video stream from a content source, and a video plane is established based on the main content video stream. The video plane includes an original object. A graphics plane is generated which bears an image of a replacement object. The graphics plane is overlaid on the video plane such that the replacement object completely overlaps the original object and only the original object. If desired, a billing event based at least in part on the overlaying of the graphics plane on the video plane. Both the original object and replacement object can be beverage containers.

In another embodiment, an apparatus includes a TV display, a processor associated with the TV, and a tangible computer-readable storage medium accessible to the processor and bearing instructions to cause the processor to execute logic. The logic includes receiving a main content video stream from a content source, with a video plane being established based on the main content video stream. The main content video stream is a full video stream, and the logic executed by the processor can also include generating a graphics plane bearing an image of a new object not in the video plane and overlaying the graphics plane on the video plane such that the new object appears with the main content video stream.

In another aspect, a method includes receiving content on plural side channels from a TV content source. The contents of the side channels are keyed to respective rating settings. A user-input ratings setting to the TV is accessed and used to select a side channel corresponding to the user-input ratings setting. A graphics plane is established using the side channel corresponding to the user-input ratings setting and then overlaid onto the video plane to thereby conform a composite image that is displayed on the TV to the user-input ratings setting.

### BRIEF DESCRIPTION OF DRAWINGS

For a more complete understanding of the invention, reference is made to the following description and accompanying drawings, in which

FIG. 1. is a view of a video plane and graphic plane.

FIGS. 2a-2c are views of the graphic content dynamically moving across the graphic plane thereby restoring the entire video.

FIG. 3 is a diagram of frame information for synchronizing of the graphic content with the video plane.

FIGS. 4a-c are system diagrams of embodiments of the equipment necessary for frame synchronization with graphic content.

FIG. 5 is a block diagram of an example system for executing present logic, with internal components of the TV shown schematically;

FIG. 6 is a flow chart showing example logic for using a graphics plane overlaid on a video plane to establish a composite moving image that is appropriate for a rating input by an owner of the TV;

FIG. 7 is a flow chart showing example logic for using a graphics plane to overlay, for a fee, placards in a video stream with content in a graphics plane;

FIG. 8 is a flow chart showing example logic for using a graphics plane to automatically overlay placards in a graphics plane onto a full video stream and then remove the placards for a fee;

FIG. 9 is a flow chart showing example logic for using a graphics plane overlay to alter objects in a video stream; and

FIG. 10 is a flow chart showing example logic for using a graphics plane overlay to add objects to a video image.

### DETAIL DESCRIPTION OF THE PREFERRED EMBODIMENT

### Definitions

Included are the following definitions which are set forth and are intended to be used when reviewing the matter contained in the below description and shown in the accompanying drawings to be interpreted as illustrative and not in a limiting sense.

Video—a digital video signal provided from content providers, including but not limited to cable companies, satellite providers and pay per view providers.

Video Channel—a designated frequency for carrying modulated video content.

Video plane—internal hardware device used for the scan out to a display.

Graphic plane—internal hardware device used for graphic overlaying on the video.

Graphic content—the package of information sent from the content provider that specifies data to be overlaid on the displayed video.

Video content—video information intended for display on a display device.

Graphic overlay—graphic plane on the video for display.

Graphic plane information—the current content data of the graphic display plane.

Meta-data—a collection of information that encompasses data transmitted with the video signal. The Meta-data contains information about the video signal and is transmitted separately from the video sent by the content provider. In a typical embodiment the Meta-data will be transmitted in the user data section of a MPEG transport stream.

Video signal—the MPEG 2 video data sent from the content provider.

Graphics Data—data that describes the image to overlay the video.

Frame synchronizing data—the portion of the graphic content that specifies which frame or frames of the video the graphic data is to be supplied too.

Graphic information—same as graphic content.

Displayed video—the visual output of a particular video channel.

Interrupt signal—the signal generated by the audio video decoder to the CPU specifying frame or frames received from a tuner or other front end device.

Audio-Video data or information—refers to video and/or audio related to video.

### DETAILED DESCRIPTION

Referring first to FIG. 1, a video plane together with a graphic plane and graphic content is depicted, indicated generally at 100. Video plane 110 is in tandem with graphics plane 130. The position of the censored portion 120 of the video plane is the same as the portion shown on the graphic plane 140. The graphic plane 130 is typically used for on screen displays of television or set top box controls as well as closed captioned text.

In the embodiment shown, the censored portion of the video plane 120 may be overlaid with the appropriate content of the graphics plane 130. The viewer then perceives a complete uncensored video.

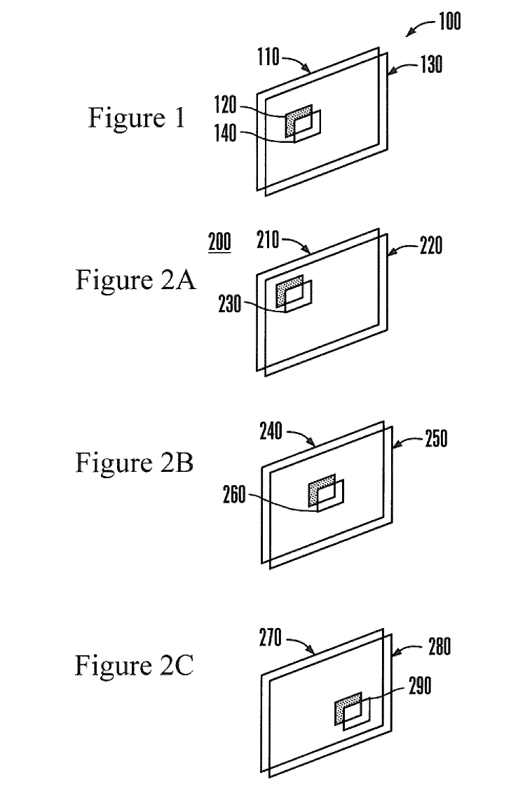

Referring next to FIGS. 2a-c, a positioning of the graphic content in the graphics plane in accordance with example embodiments of the invention is depicted. When using MPEG 2 video, the beginning and ending time for a series of frames are specified in terms of the presentation time stamp (PTS) of the frames. These presentation time stamps are typically present in every frame to every third frame which is sufficient for frame synchronization. The overlaying regions for the graphic content in the frames are specified by coordinates X,Y. As is shown in FIG. 2a, a graphic content 230 located in the graphic plane is positioned at position X, Y with a presentation time stamp of 1234567 of that graphic plane.

Additionally, the matching video plane has a presentation time stamp of 1234567 of its particular frame. Thus, the position of the graphic content in the graphic plane is matched to the video frame 210 in the video plane. This matching operation is performed by matching the presentation time stamp or other frame identifier information of the video frame with that of the graphic frame. Intra-frame positioning is described below, and is consistent with the MPEG standard, the video frames may be an I frame, a B frame or a P frame for digital video.

Also, as noted in FIGS. 2b and 2c, further matching operations are shown in accordance with example embodiments of the invention. For example in FIG. 2b, video frame 2 having a presentation time stamp of 1234568 is matched with graphic content 260 of the graphic plane having a corresponding presentation time stamp of 1234568. Thus the video plane 240 and the graphic plane 250 are both synchronized by bringing together the same presentation time stamps. In FIG. 2c, the video frame 3 having a presentation time stamp of 1234569 of the video plane 270 is matched to graphic plane 280 having graphic content 290. As a result, the graphic plane overlays and dynamically tracks the censored portion of the video plane to create a perception of a complete video program.

During an implementation of the above matching operation, an interrupt is generated from a video decoder signal to a microprocessor when a next frame of video is ready for displaying. Graphic content is initially decoded into a buffer or circular queue slightly ahead of the video such that when a video frame which includes the graphic content is signaled as ready by an interrupt signal, the video is ready for display on the graphic plane. The interrupt signal sent from a video decoder either provides the frame timing information or is set up so that the information is readily available at a predetermined location.

Additionally, each of the graphic contents of the graphic frame in the graphic plane is matched with the video frame in the video plane at positions designated by different X, Y within the video frame. Hence each of the above video frames 1, 2, and 3, each has its corresponding graphic content at a different X, Y location. Therefore, when viewing multiple video frames, the graphic content can be placed at different locations within these multiple video frames. The data being displayed can also vary with each frame. The graphics images being overlaid are not required to be static groups of pixels associated with motion vector data from the MPEG video.

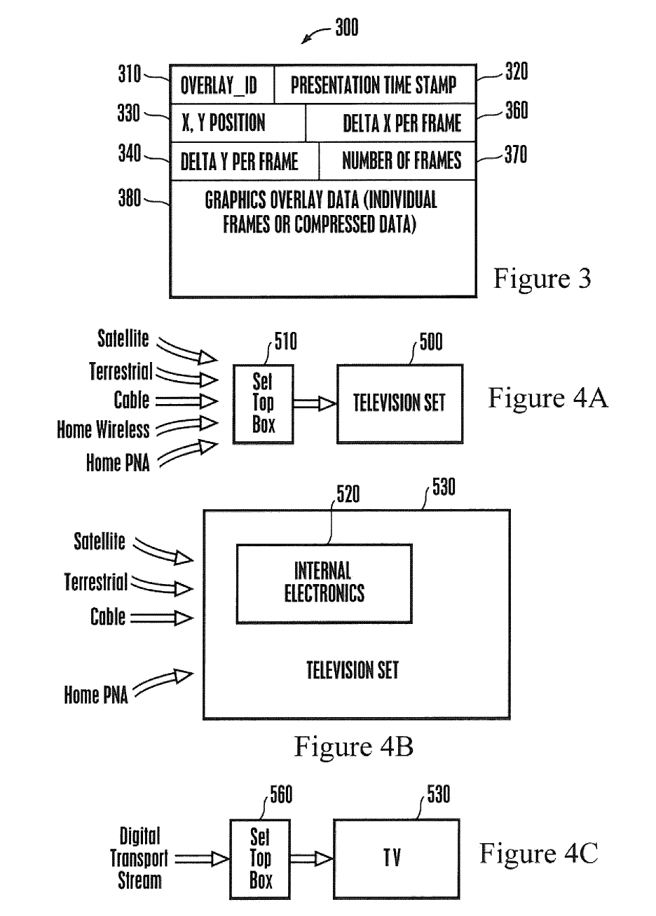

FIG. 3 shows an example of an embodiment of the present invention comprising the frame identifier information necessary to specify the location over a series of video frames for synchronizing the graphics content with the displayed video. The graphic content information may be added in real time to a live presentation in progress. The frame identifier information comprises an overlay ID 310, a presentation time stamp 320, X and Y position 330, delta X per frame 360, delta Y per frame 340, number of frames 370 and graphic overlay data (individual frame or compressed data) 380. The identifying information contains the necessary information for overlaying of graphic content and audio by a properly equipped set top box (STB) or television.

FIG. 4a comprises one embodiment of the typical equipment used in some implementations of the present invention. FIG. 4a comprises a STB 510, a television set 500, and a multitude of input sources such as satellite, terrestrial, cable, and home wireless to receive the multimedia presentation. The STB 510 accepts and processes the multimedia presentation and passes the result to the television set 500. As an example, the STB 510 uses MPEG 2 video decoders to render the graphic content in the graphic plane which overlays the video plane. These decoders vary in sophistication by the on screen display (OSD) that they can offer. In the preferred embodiments, the video and audio decoders may be implemented together on a single chip. They may also be incorporated in other ways such as having an intermediate IC used to decode the desired analog signal formats of NTSC, PAL etc. FIG. 4b discloses another typical set up, however, here the internal electronics 520 of the television set 530 are included in the requisite front end equipment for receiving and decoding the input sources.

FIG. 4c shows a digital transport stream DTS being connected to a STB. Included in the DTS are the meta-data, electronic program guides, graphic content, television channel etc. The STB 560 receives the input from the DTS and extracts the censored video and graphic content therefrom.

Also, audio content can be inserted by a set top box audio decoder or a set top box processor and using frame synchronizing information, the audio content can be replaced with the associated frames.

Finally, the Meta-data used for synchronizing the video plane with the graphic content can be recorded to a hard drive for personal video recording along with the video content. When the video content is replayed from the hard drive the Meta-data is used as before complete the displayed video. As before, the video may be viewed in it's entirety by the user but the complete video cannot be recorded to a VCR or recordable optical disk.

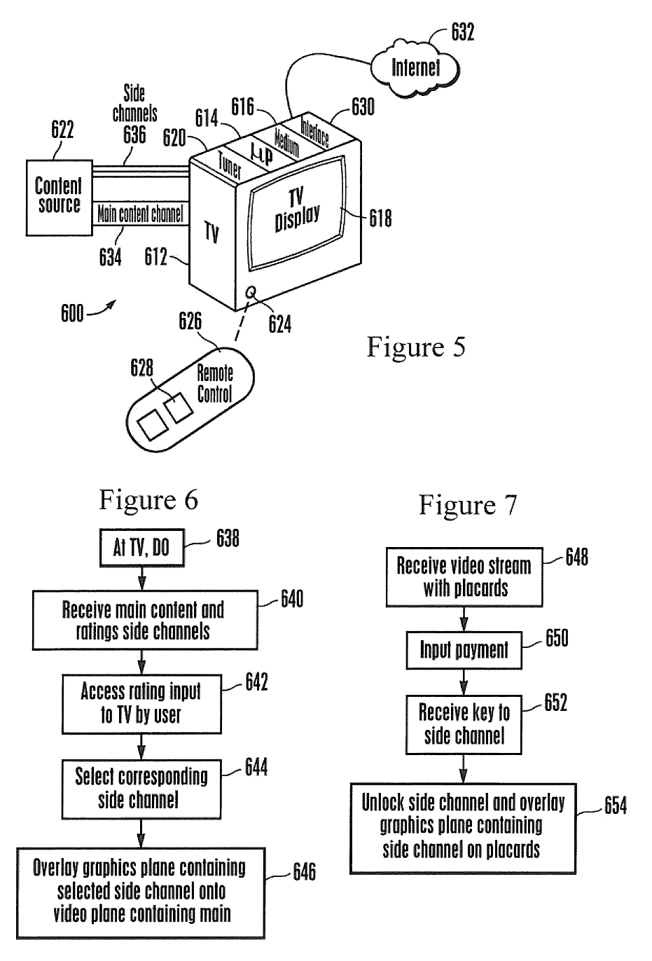

Now referring to FIGS. 5-10 for additional example embodiments, a system is shown, generally designated 600, which includes a TV 612 having a TV processor 614 accessing a computer readable storage medium 616 such as but not limited to solid state storage and/or disk-based storage to present TV signals on a TV display 618, such as a flat panel LCD display or other type of matrix display or a plasma display or other suitable type of TV display. The signals are received through a TV tuner 620 that communicate with a suitable source 622 of TV signals such as but not limited to a cable head end, satellite receiver, terrestrial broadcast receiver, etc. The storage medium 616 may store logic described below for execution by the processor 614, as well as store user-input ratings settings, although other processors and/or storage media may be associated with the display 618 for executing present logic, e.g., a processor and storage medium in a set-top box.

The TV 612 typically includes a wireless receiver 624 such as an infrared receiver for receiving user command signals from a remote control 626. The remote control 626 typically includes one or more manipulable input elements 628 such as keys for enabling a user to input commands to the TV processor 614.

As shown in FIG. 5, the TV 612 may also include a network interface 630 such as but not limited to a wired or wireless modem for enabling the TV processor 614 to communicate with a wide area network such as the Internet 632. The interface 630 may be incorporated in the TV chassis or in a set-top box or set-back box that is separate from the TV chassis and operably engaged therewith. The below-described communication from the TV 612 to external recipients thus may be effected through back-channels provided either through a set-top box to a TV service provider (e.g., over a TV signal cable) and/or through the Internet 632 to a destination server.

FIG. 5 shows that in accordance with further description below, in some embodiments the content source 622 provides TV signals to the TV 612 over a main content channel 634. Video received on the main content channel 634 is presented by the TV 612 in its video plane, which appears on the TV display 618. Furthermore, ancillary image information which may be regarded as “graphics data” is provided by the content source 622 to the TV 612 over one or more side channels 636. In accordance with description below, the TV 612 may select content from one of the side. channels 636, place the content in the graphics plane of the TV 612, and then overlay the graphics plane onto the video plane.

With more specificity and now referring to FIG. 6, in an example embodiment block 638 indicates that the TV executes the following logic. At block 640, content on the main and side channels 634, 636 is received. Each side channel 636 carries content that is respectively rated differently than the content of the other side channels. For example, one side channel 636 may carry “PG” content, another can carry “PG-13” content, yet another side channel can carry “NC-17” content, etc.

Also, a content rating that has been input by a user of the TV is accessed at block 642. At block 644, the side channel 636 corresponding to the rating accessed at block 642 is selected by the TV. Then, at block 646 the content of the side channel is placed in the graphics plane and overlaid onto the main channel 634 content presented in the video plane, for display of the composite image on the TV display 618.

The content in the graphics plane overlays only predetermined portions of the content in the video plane, and only the predetermined portions. Portions of the video plane other than the predetermined portions are not overlaid by content in the graphics plane.

Equivalently, the content in the graphics plane overlays only predetermined “holes” in the video plane, i.e., only predetermined portions in the video plane having no content, and only the predetermined “hole” portions are overlaid. Portions of the video plane other than the predetermined “hole” portions are not overlaid by content in the graphics plane. In such an embodiment, the content received on the main channel 634 might not be objectionably rated at all, since objectionable portions resulting in, e.g., X-ratings are removed, with the side channels 636 respectively representing “X”, “R”, “G”, etc. rated content to fill the holes to comply with the particular ratings setting of the TV. Replacement audio likewise can be received on the side channels and conform to the respective ratings of the content in the side channels to replace, at predetermined points in the audio-video stream, objectionable audio clips.

It may now be appreciated that in FIG. 6, small sections of video in the video frame from the main channel 634 are overlaid with alternate content received on a side channel 636 and placed in a graphics frame which is overlaid on the video plane, to thereby conform to the rating setting of the TV. In non-limiting embodiments the frame synchronizing data-described previously can be used for this purpose.

Accordingly, instead of forcing the content source 622 to provide multiple full versions of a video stream, one for each of plural ratings, and then bear the responsibility to manage which rating of each film is sent to which customer on a customer-by-customer, the content source 622 need only provide a single instance of the content (e.g., X-rated), which is then modified at a customer TV to comply with the ratings setting for-that TV. Thus, the rating decision is made at the customer television and can be adapted in real time if the customer changes the rating. If the entire content (for example, an X-rated program) is inappropriate for the current ratings setting of the TV 612, the portions of the content giving rise the objectionable rating are blocked or replaced by alternate content in the overlaid graphics frame to produce a composite image that has content conforming to the TV rating setting.

As an example, suppose the video content received on the main content channel 634 has a nude scene. Depending on the rating setting of the TV 612, particular sections in the video plane can be replaced with blurred imagery, black bats, digitally matted clothing, etc. in the graphics plane. Or, the entire scene may be blocked from view by alternate content in the graphics plane until the inappropriate material is no longer presented in the video plane. In some cases, the rating setting of the TV may indicate the side channel data is not needed.

Thus, video in a side channel 636 that is drawn onto the graphics plane of the TV 612, in addition to being an obstruction, can also be a replacement video portion (e.g., a bikini top to replace an otherwise nude breast scene). Thus, a “hole” (no content) may be provided in a predetermined area of the video provided on the main channel 634, with content from a side channel 636 being placed in the graphics plane and overlaid onto the “hole” in the video plane. In such an embodiment, one of the side channels 636 may carry X-rated content. In lieu of replacement video that seamlessly joins with the video in the video frame, the content in the graphics plane may be an advertisement, or a programmable message by a parent admonishing a youthful viewer that he should change to another, less objectionable channel.

FIG. 7 shows additional logic in which a video stream is received on the main content channel 634 at block 648 with portions of the video covered with placards that may indicate that the “full” content can be unlocked on a pay per view basis. This allows both the teaser material and the paid for content to be provided in a single package. Purchase/rent selection information is sent from the TV 612 to the content source 622 at block 650. Upon purchase/rent verification, a signal that may include a side channel decryption key is then sent to the TV at block 652 to unlock the replacement material in a side channel 636 channel to overlay content from the side channel onto the areas in the video plane where the placards are placed. In lieu of transmitting the graphics plane material on a side channel 636, the information used in the graphics plane to overlay the placards can be transmitted within the video stream in the main channel 634.

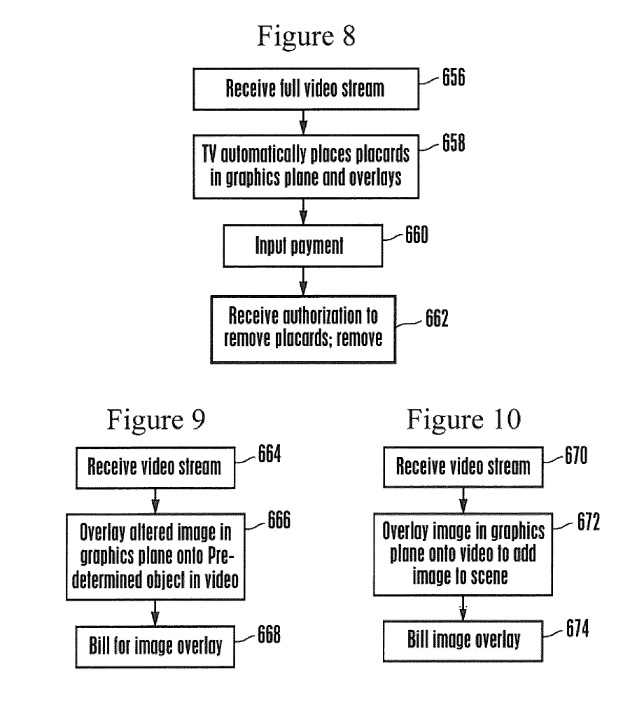

FIG. 8 illustrates a banner advertisement-based pay per view model, in which unaltered (full) content is received on the main channel 634 at block 656 and the TV 612 automatically places placards in predetermined locations in a graphics plane at block 658 to overlay the placards on the video plane. The predetermined locations, and the placards themselves, may be stored in the TV memory 616 or received real time in a side channel 636 along with the main video stream in the main content channel 634. Payment information (e.g., in accordance with payment instructions on the placards) is input at block 660 and assuming the payment is authenticated properly, authorization is received by the TV at block 662 to remove the placards.

FIG. 9 illustrates a method for replacing product placement items. Understanding that with computer and digital image manipulation, video can be altered in many interesting ways, at block 664 a video stream is received with, e.g., an original image in it, such as a particular product, e.g., a beverage container. At block 666 an altered version of the original image is presented in the graphics plane, which is overlaid onto the original image in the video plane. In other words, an image of a replacement object is established in the graphics plane which, when overlaid on the video plane, completely overlaps the original image and only the original object, i.e., the contour of the replacement object is substantially identical to the contour of the original object.

The altered (replacement) image may be received on one of the side channels described above in real time with the original video received on the main content channel. A billing event is generated at block 668, in which, e.g., the purveyor of the altered version of the image is billed.

To illustrate with examples, suppose a stream received on the main channel 634 depicts a character drinking a can of soda labeled with product company A. A replacement image of the can of soda is created, labeled with product company B, placed into the graphics plane, and overlaid onto the product company “A” image in the video plane so that the composite video appears on the TV display 618 as though the character were drinking a soda from product company B.

As another illustration, a video element (and only the video element, such as a drink) in black and white in an old film may be replaced by a color image that is rendered in the graphics plane and overlaid onto the original black and white video element. This concept can be extended to erecting graphical billboards in a video for local business advertising.

FIG. 10 shows that instead of replacing one product image with the image of another competing product as is done in FIG. 9, a new product altogether may be added to a scene. At block 670 a video stream is received with a full screen video image in it. At block 672 an image of an object not in the full screen image is presented in the graphics plane, which is overlaid onto the original image in the video plane in a predetermined, typically discreet area such as the image of a table to in effect add the object in the graphics plane to the composite video that is displayed on the TV display 618. The new image may be received on one of the side channels described above in real time with the original video received on the main content channel. A billing event is generated at block 672, in which, e.g., the purveyor of the new object is billed.

To illustrate with examples, a bar scene in the video plane in which two characters are having a conversation at a table may be overlaid with a graphics plane containing an item from an entity to be billed. The item in the graphics frame can be synchronized to be overlaid onto an image of table in the video plane, thus without unduly impacting the scene or the plot of the movie.

While the particular METHOD AND APPARATUS FOR OVERLAYING GRAPHICS ON VIDEO is herein shown and described in detail, it is to be understood that the subject matter which is encompassed by the present invention is limited only by the claims.

What is claimed is:

1. Apparatus, comprising:
TV display;
processor associated with the TV; and
tangible computer-readable storage medium accessible to the processor and bearing instructions to cause the processor to execute logic comprising:
receiving a main content video stream from a content source, a video plane being established based on the main content video stream;
receiving plural graphics content streams, each graphic content stream being associated With a respective content rating;
accessing a rating setting input by a user of the TV display;
based on the rating setting, selecting a first one of the graphics content streams;
establishing a graphics plane using the first graphics content stream; and
overlaying the graphics plane onto the video plane.

2. The apparatus of claim 1, wherein the graphics content stream in the graphics plane covers at least one predetermined region of the video plane, the predetermined region not being the entire video plane.

3. The apparatus of claim 2, wherein the predetermined region of the video plane is devoid of content.

4. The apparatus of claim 2, wherein the predetermined region of the video plane contains content that is screened from view by the graphics content stream in the graphics plane.

5. The apparatus of claim 1, wherein the plural graphics content streams are received from the content source.

6. The apparatus of claim 1, wherein the plural graphics content streams are received from the content source on side channels associated with a main channel on which the main content video stream is received.

7. The apparatus of claim 1, wherein the plural graphics content streams are received from the content source on a main channel on which the main content video stream is received.

8. Apparatus, comprising:
TV display,
processor associated with the TV; and
tangible computer-readable storage medium accessible to the processor and bearing instructions to cause the processor to execute logic comprising:
receiving a main content video stream from a content source, a video plane being established based on the main content video stream;
receiving at least one graphics content stream;
establishing a graphics plane using the graphics content stream; and
overlaying the graphics plane onto the video plane, wherein the graphics content stream in the graphics plane covers at least one predetermined region of the video plane, the predetermined region not being the entire video plane, wherein the predetermined region of the video plane includes a placard indicating that “full” content can be obtained for remuneration, wherein upon verification of a remuneration signal from the processor, a signal is received by the processor to use the graphics content stream, the graphics content stream being used to generate the graphics plane.

9. Apparatus, comprising:
TV display;
processor associated with the TV; and
tangible computer-readable storage medium accessible to the processor and bearing instructions to cause the processor to execute logic comprising:
receiving a main content video stream from a content source, a video plane being established based on the main content video stream;
wherein the main content video stream is a full video stream, and the logic executed by the processor comprises automatically placing at least one placard in a graphics plane and overlaying the graphics plane on the video plane to block at least one predetermined location of the video plane, the logic removing the placard from view upon receipt of an authorization signal.

10. Apparatus, comprising:
TV display;
processor associated with the TV; and
tangible computer-readable storage medium accessible to the processor and bearing instructions to cause the processor to execute logic comprising:
receiving a main content video stream from a content source, a video plane being established based on the main content video stream, the video plane including at least one original object;
wherein the main content video stream is a full video stream, and the logic executed by the processor comprises generating a graphics plane bearing an image of a replacement object and overlaying the graphics plane on the video plane such that the replacement object completely overlaps the original object and only the original object.

11. The apparatus of claim 10, comprising generating a billing event based at least in part on the overlaying of the graphics plane on the video plane.

12. The apparatus of claim 10, wherein both the original object and replacement object are beverage containers.

13. Apparatus, comprising:
TV display;
processor associated with the TV; and
tangible computer-readable storage medium accessible to the processor and bearing instructions to cause the processor to execute logic comprising:
receiving a main content video stream from a content source, a video plane being established based on the main content video stream;
wherein the main content video stream is a full video stream, and the logic executed by the processor comprises generating a graphics plane bearing an image of a new object not in the video plane and overlaying the graphics plane on the video plane such that the new object appears with the main content video stream.

14. Method comprising:
receiving content on plural side channels from a TV content source;
the contents of the side channels being keyed to respective rating settings;
accessing a user-input ratings setting to the TV;
the TV selecting a side channel corresponding to the user-input ratings setting;
establishing a graphics plane using the side channel corresponding to the user-input ratings setting;
overlaying the graphics plane onto the video plane to thereby conform a composite image that is displayed on the TV to the user-input ratings setting.

15. The method of claim 14, wherein the graphics content stream in the graphics plane covers at least one predetermined region of the video plane, the predetermined region not being the entire video plane.

16. The method of claim 15, wherein the predetermined region of the video plane is devoid of content.

17. The method of claim 15, wherein the predetermined region of the video plane contains content that is screened from view by the graphics content stream in the graphics plane.

18. The method of claim 14, wherein the plural graphics content streams are received from the content source on side channels associated with a main channel on which the main content video stream is received.
